(19) United States
(12) Patent Application Publication
(10) Pub. No.: US 2004/0032644 A1
(43) Pub. Date: Feb. 19, 2004

(54) Optical fiber amplifiers

(76) Inventor: Christopher James Griffin, Allentown, PA (US)

Correspondence Address: Lester H. Birnbaum, 6308 Sauterne Drive, Macungie, PA, 18062, US

(21) Appl. No.: 10/219,416

(22) Filed: Aug. 15, 2002

(51) Int. Cl. H01S 3/00

(52) U.S. Cl. 359/341.1

(57) ABSTRACT

An optical device and method of manufacture where the device includes a housing within which is a wavelength division multiplexer component. An optical fiber is coupled directly to the component without any splices. The fiber includes a dopant which causes light from the component to be amplified as it propagates therethrough.

### FIELD OF THE INVENTION

The present invention relates generally optoelectronics and, more particularly, to an optical fiber amplifier component.

### BACKGROUND OF THE INVENTION

Optical fiber systems have become increasingly important in modern telecommunications primarily due to their huge information handling capacity. Such systems usually include a transmitter with one or more lasers, an optical modulator, an optical fiber to transmit the optical signal, and an optical receiver on the other end to convert the optical signal to an electrical signal. Critical portions of the system are optical amplifiers to boost the optical signal.

One type of optical amplifier is the Erbium-Doped Fiber Amplifier (EDFA). Such amplifiers usually include one or more pump lasers, and a wavelength division multiplexer for combining the optical signal with the pump signal at the output of the amplifier component. This output is coupled to an optical fiber which is doped with some element, usually erbium, in order to amplify the optical signal as it passes through the doped fiber. The amplifier component may also include one or more optical isolators to prevent back-reflection of the optical or pump signals.

At present, the amplifier contains a WDM component with, for example, a fused fiber or micro-optic construction and having fused and stretched fiber pigtails comprising standard transmission fiber (such as SMF-28) from the outputs of the component. One pigtail is then spliced to an erbium-doped fiber. This additional splicing operation adds cost and complexity to the final optical amplifier, and can add insertion loss which reduces the amplifier performance and can have a negative effect on long-term amplifier reliability.

It is desirable, therefore, to reduce the cost and complexity in the fabrication of optical fiber amplifiers.

### SUMMARY OF THE INVENTION

The present invention in accordance with one aspect is an optical device comprising a housing. Within the housing is at least one wavelength division multiplexer component. An optical fiber is coupled directly to the component without any splices. The fiber includes a dopant which causes light from the component to be amplified as it propagates therethrough.

In accordance with another aspect, the invention is a method of fabricating an optical device. A wavelength division multiplexer component is placed within a housing. An optical fiber including a dopant which causes amplification of light propagating therethrough is aligned with the component so that light is coupled from the component to the fiber without any splices in the fiber.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice in the optoelectronics industry, the various features of the drawing are not to scale. On the contrary, the dimensions of the various features are arbitrarily expanded or reduced for clarity. Included in the drawing are the following figures:

FIG. 1 is a schematic block diagram of an optical device in accordance with an embodiment of the invention;

FIG. 2 is a schematic block diagram of an optical device in accordance with another embodiment of the invention; and

FIG. 3 is a schematic illustration of a portion of the embodiment of FIG. 2.

### DETAILED DESCRIPTION OF THE INVENTION

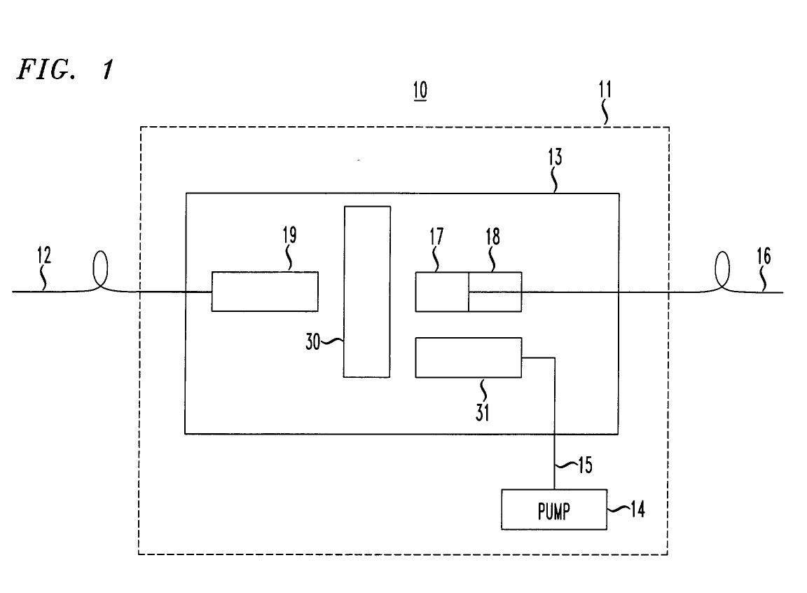

Referring now to the drawing, wherein like reference numerals refer to like elements throughout, FIG. 1 is a schematic block diagram of an embodiment of the invention. The device, 10, is part of an optical fiber amplifier. The device includes a housing, illustrated as dashed line 11, which is typically made of stainless steel. A first optical fiber, 12, receives the optical signal from a laser (not shown) or other device, and couples the light to a wavelength division multiplexer (WDM) illustrated as block 13. The first optical fiber, 12, is the standard transmission fiber, such as SMF 28. The WDM can be any of the standard types used in the industry for combining light from different sources. Typically, the signal light for telecommunications has a wavelength of approximately 1550 nm, but the invention is not limited to particular wavelengths.

The input fiber, 12, is coupled to a collimator, 19, which, in turn, couples the light to a standard optical filter, 30. The WDM, 13, also receives light from a standard pump laser, 14, via a single mode fiber, 15. Typically, the pump light has a wavelength of approximately 980 nm or 1480 nm for telecommunications applications, but again, the invention is not so limited. In this example, the pump laser, 14, is shown within the housing, 11, but could also be located outside the housing. The pump light is coupled to the filter, 30, through a standard collimator, 31.

The combined signal and pump light from the WDM filter, 30, is coupled to a second optical fiber, 16, which typically extends outside the package housing, 11, for connection to other components (not shown). In this embodiment, the fiber, 16, is coupled to the WDM filter utilizing a standard Graded Index of Refraction (GRIN) lens, 17, for focusing the light. The input end of the fiber, 16, is held in place by a standard ferrule, 18, which is typically made of glass. The ferrule is bonded to the lens, 17, typically with epoxy, and the combination lens and ferrule is aligned with the output of the WDM, 13, by standard techniques such as active alignment. The lens-ferrule combination is held in place typically by epoxy.

The second optical fiber, 16, is not the standard transmission fiber used for the input into the device, 11, nor the standard fused and stretched fiber usually used in WDM components. Rather, the fiber, 16, is doped with an impurity such as Erbium which will cause the signal light from the WDM to be amplified. While not being bound by any theory, the amplification is a result of the pumping of the impurities to higher energy levels by the pump light according to accepted theories of Erbium-Doped Fiber Amplifiers. However, it will be noted that the doped fiber, 16, is directly coupled to the WDM with no splices, therefore simplifying the fabrication of the devices and lowering the cost of fabrication. The doped fiber, 16, typically has a smaller core diameter than standard transmission or fused fiber. In particular, the core diameter is generally in the range 2 to 10 microns, and preferably in the range 4 to 7 microns.

While Erbium has been described as the dopant, other dopants such as Thullium, Praseodymium, and Neodymium can be utilized. Generally, the dopant concentration is in the range 1,000 to 50,000 ppm.

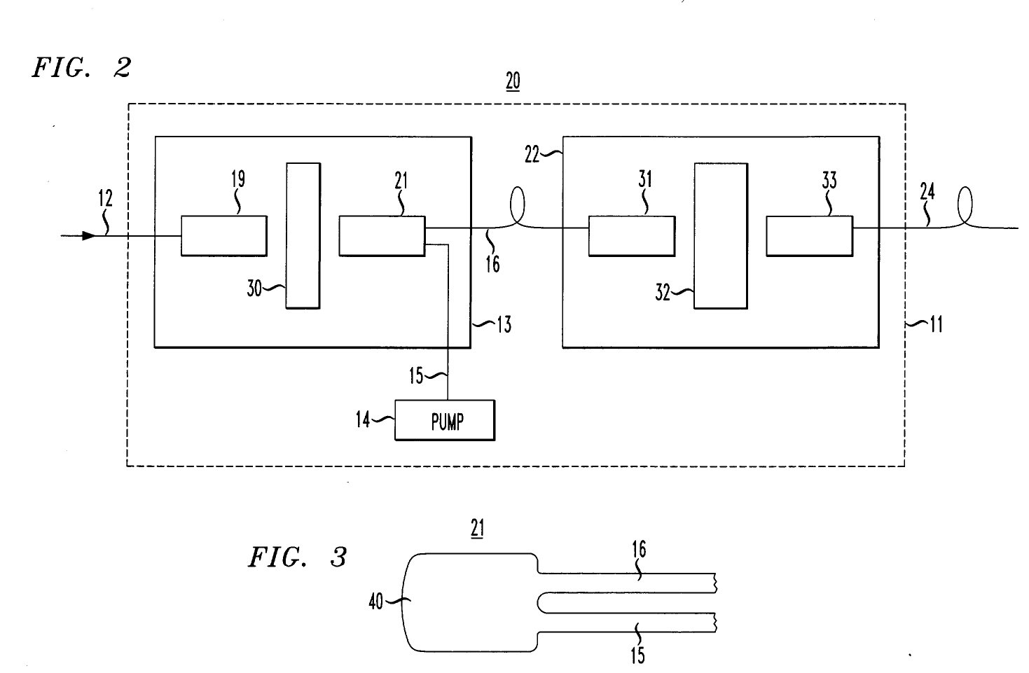

FIG. 2 illustrates another embodiment of an optical device, 20, in accordance with the invention. Again, signal light is received on a standard transmission fiber, 12, and incident on a WDM, 13, along with light from a pump laser, 14. Here, however, the input ends of doped fiber, 16, and pump fiber, 15, are optically coupled to the WDM filter, 30, by a standard fused fiber collimator, 21, which is also shown schematically in FIG. 3 where the collimator lens is illustrated by 40. The output end of fiber, 16, is coupled by means of a collimator, 31, to a standard isolator, 22, which prevents back-reflection of the signal and pump light. The standard Faraday Rotator and isolator subassembly are illustrated by block 32. The output of the isolator, 22, is coupled to the input end of a third fiber, 24, which extends outside the housing, 1, for optical connection to other components (not shown). The input end of the fiber, 24, is coupled to the isolator, 22, by another fused fiber collimator, 33, which may or may not be identical to collimator 19. Fiber, 24, is typically a standard transmission fiber.

It will be noted, again, that there are no splices in the coupling of the doped fiber, 16, to the WDM, and, in addition, there are no splices in the doped fiber connection to the isolator 22. Thus, the expense and cost of splicing a doped fiber to components in the package is avoided, as well as the additional insertion loss from those splices. Reliability of the device is also improved.

While the embodiment of FIG. 2 shows one end of the doped fiber coupled to an isolator, it could be coupled to other components, such as an additional WDM or a gain flattening filter.

Although the invention has been described with reference to exemplary embodiments, it is not limited to those embodiments. For example, while the doped fiber has been shown as coupled by means of fused fiber collimators and GRIN lens-ferrule assemblies, other coupling structures, such as lenses formed on the ends of the fibers, could be employed. Therefore, the appended claims should be construed to include other variants and embodiments of the invention which may be made by those skilled in the art without departing from the true spirit and scope of the present invention.

What is claimed:

1. An optical device comprising:
a housing;
at least one wavelength division multiplexer component within the housing; and
an optical fiber coupled directly to the component without any splices, the fiber including a dopant which causes light from the component to be amplified as it propagates therethrough.

2. The device according to claim 1 wherein the dopant is selected from the group consisting of Erbium, Thullium, Praseodymium, and Neodymium.

3. The device according to claim 1 wherein the fiber has a core diameter in the range 4 to 7 microns

4. The device according to claim 1 wherein the device further comprises an isolator coupled to the wavelength division multiplexer component through the fiber with no splices therebetween.

5. The device according to claim 1 wherein the fiber is coupled to the component through a graded index of refraction lens.

6. The device according to claim 1 wherein the fiber is coupled to the component through a collimator.

7. The device according to claim 1 wherein the fiber is coupled to the component through a lens formed on an end of the fiber.

8. The device according to claim 1 wherein the dopant concentration is within the range 1,000 to 50,000 ppm.

9. The device according to claim 1 wherein the device is an amplifier.

10. A method of fabricating an optical device comprising the steps of:
placing a wavelength multiplexer component within a housing; and
aligning with said component an optical fiber to provide optical coupling to said component without any splices in the fiber, the fiber including a dopant which causes light from the component to be amplified as it propagates through the fiber.

11. The method according to claim 10 wherein the fiber is aligned by active alignment.

12. The method according to claim 10 wherein the dopant is selected from the group consisting of Erbium, Thullium, Praseodymium, and Neodymium.

13. The method according to claim 10 wherein the fiber has a core diameter in the range 4-7 microns.

14. The method according to claim 10 further comprising placing in the housing an isolator coupled to the wavelength division multiplexing component through the fiber without any splices therebetween.

15. The method according to claim 10 wherein the dopant concentration is within the range 1,000 to 50,000 ppm.

16. The method according to claim 10 wherein the fiber is coupled to the component through a graded index of refraction lens.

17. The method according to claim 10 wherein the fiber is coupled to the component through a collimator.

18. The method according to claim 10 wherein the fiber is coupled to the component through a lens formed on an end of the fiber.
